(19) United States
(12) Patent Application Publication
(10) Pub. No.: US 2023/0338919 A1
(43) Pub. Date: Oct. 26, 2023

(54) SORBENT COMPOSITIONS AND METHODS OF MANUFACTURE FOR USE IN CONCENTRATING LITHIUM FROM BRINES

(71) Applicants: E3 METALS CORP., Calgary (CA); THE GOVERNORS OF THE UNIVERSITY OF ALBERTA, Edmonton (CA)

(72) Inventors: Daniel ALESSI, Calgery (CA); Salman SAFARIMOHSEN-ABAD, Edmonton (CA)

(73) Assignees: E3 METALS CORP., Calgary, AB (CA); THE GOVERNORS OF THE UNIVERSITY OF ALBERTA, Edmonton, AB (CA)

(21) Appl. No.: 17/787,134

(22) PCT Filed: Dec. 18, 2020
(86) PCT No.: PCT/CA2020/051763

§ 371 Date: Jun. 17, 2022

Related U.S. Application Data
(60) Provisional application No. 62/951,859, filed on Dec. 20, 2019.

(51) Int. Cl. B01J 20/04; C02F 1/28; B01J 39/10

(52) U.S. Cl. CPC B01J 20/041; C02F 1/281; B01J 39/10; C02F 2103/08

(57) ABSTRACT

Compositions and methods of preparing sorbent compositions (SCs) and protonated sorbent compositions (PSCs) for use in concentrating lithium from native brines are described. In particular, SCs of the general formula Li_{1.3-1.6}Mn_{1.6-1.7}O₄, methods of preparing the SCs and PSCs that have improved properties for lithium extraction and concentration over single and multiple cycles are described.

### RELATED APPLICATIONS

This application is related to U.S. Provisional Application 62/951,859 filed Dec. 20, 2019, which is incorporated herein by reference in its entirety.

### FIELD OF THE INVENTION

Compositions and methods of preparing sorbent compositions (SCs) and protonated sorbent compositions (PSCs) for use in concentrating lithium from natural brines are described. In particular, SCs of the general formula Li_{1.3-1.6}Mn_{1.6-1.7}O₄, methods of preparing the SCs and PSCs that have improved properties for lithium extraction and concentration are described.

### BACKGROUND OF THE INVENTION

With the increase in demand for energy storage for use in a variety of industries including portable electronic devices, large scale grid storage and electric vehicles, the demand for lithium chemistry batteries and hence, lithium continues to grow.

Lithium is naturally present in a number of chemical forms and can be found in a number of key locations around the world. Depending on its natural form, lithium can be extracted, concentrated and processed using a number of technologies. These technologies can include roasting and leaching of minerals such as spodumene, solar evaporation of brines such as salar brines and direct brine processing.

In the case of lithium being solubilized in native brine solutions, direct brine processing has several advantages over purifying lithium from minerals including environmental impact, capital expenditures, and/or speed of processing. Direct brine processing also has similar advantages over solar evaporation techniques.

Brine processing generally seeks to concentrate lithium from ground water and, in particular, formation water associated with certain natural formations. Generally, these brines may be referred as natural brines and are generally characterized as having a relatively high concentration of dissolved cations such as sodium and calcium and relatively low concentrations of lithium.

In one example, lithium brines may also be called petro-lithium brines, or oilfield brines (OFBs) which are brines that may be associated with ground or connate water around hydrocarbon bearing formations. An example of an oilfield brine is the brine that occurs deep within the Leduc Formation in Alberta, Canada which has dissolved lithium ions in formation water. Of the total fluid contained within the pore space in the Leduc Formation, about 95% or more is oilfield brine. The Leduc reservoir exhibits exceptional flow rates and deliverability due to favorable rock properties and pressure. These brines are generally characterized as having the following approximate mineral concentrations Li 75 mg/L, Mg 3500 mg/L, Ca 20,000 mg/L, Na 50,000 mg/L, K 6500 mg/L, B 300 mg/L, Sr 800 mg/L, Si 10 mg/L, CI 150,000 mg/L and TDS 200,000 mg/L.

Generally speaking, as the concentration of lithium is relatively low and to the extent that there is a significant presence of competing ions such as Na, Ca and Mg, Li extraction methodologies are dependent on brine chemistry. For instance, some ion exchange (IX) techniques are dependent on the initial Li concentration wherein a lower Li concentration within the solution makes the concentrating process less efficient.

Moreover, the presence of competing cations within a solution makes ion exchange more difficult as the ion exchange media may be subject to competition/inhibition by these competing ions.

### Manganese Dioxide

In the past, various methodologies have been utilized with different compositions containing manganese dioxide to extract lithium from various brines. Typically, the manganese dioxide is referred to as an ion sieve, ion cage, or simply a sorbent in the literature.

Various methods used to produce an ion exchange manganese dioxide sorbent include techniques of precipitation, reflux, hydrothermal and solid phase reaction.

As a result of the foregoing, there has been a need for improved ion exchange compositions and methods of preparing precursor and PSCs that enable effective concentration of lithium through ion exchange processes.

### SUMMARY OF THE INVENTION

In its broadest form, the invention describes sorbent compositions (SCs) of the formula Li_{1.3-1.6}Mn_{1.6-1.7}O₄ having a crystal structure enabling reversable ion exchange of lithium and hydrogen within the composition. The SCs are synthesized in a lithiated form, and thereafter processed in acid to exchange lithium with hydrogen to form protonated sorbent compositions (PSCs) for subsequent use as an ion exchange media for concentrating lithium from brines.

In one aspect, the invention describes a sorbent composition (SC) of the formula Li_{1.3-1.6}Mn_{1.6-1.7}O₄ having a crystal structure enabling a reversable exchange of hydrogen and lithium ions within the composition, the sorbent composition effective for selectively concentrating lithium from a lithium brine via an ion exchange process, the crystal structure having a majority of ion exchange sites in relation to redox sites.

In various aspects:
The crystal structure has a ratio of ion exchange sites to redox sites greater than 2:1.
The crystal structure has a ratio of ion exchange sites to redox sites greater than 5:1.
The crystal structure has a ratio of ion exchange sites to redox sites greater than 15:1.
The composition has an average oxidation state greater than 3.8.
The sorbent composition is in a protonated form.

In another aspect, the invention describes a sorbent composition prepared by a co-precipitation process comprising the steps of:
a. Mixing LiOH and MnCl₂ under oxidizing conditions to form a LiMn oxide precipitate; and,
b. Separating and drying the LiMn oxide precipitate and calcining the LiMn oxide precipitate to form a calcined LiMn oxide powder.

In various aspects:
Step b includes calcining at a temperature from 100° C. to 450° C.
Step b includes increasing the temperature at a rate of 3° C./min to 10° C./min during calcination and holding the temperature at the maximum temperature for a remaining duration of a calcination time.
Step b includes maintaining an air flow through the LiMn oxide powder during calcination.
The calcination time is greater than 6 hours.
Step a is conducted in the presence of hydrogen peroxide.
The sorbent is converted to a protonated form by mixing the calcined LiMn powder oxide from step b with an acid under conditions to exchange Li within the calcined LiMn powder with protons to form a protonated sorbent composition (PSC).
The method includes the step of drying the PSC and wherein the PSC is characterized as having a sub-millimeter particle size.
The ratio of Li:Mn in step a is greater than 2:1 and less than 3:1.

In another aspect, the invention describes a sorbent composition prepared by a solid phase process comprising the step of:
a. mixing and heating LiOAc and Mn(NO₃)₂ powders with air circulation to dehydrate the powders to form a eutectic LiMn oxide powder.

In various aspects:
Step a includes heating to 100° C.
The method includes a step of first calcining the LiMn oxide powder for >6 hours at 200° C. under an active flow of air.
The method includes a step of repeating calcining the LiMn oxide powder for >6 hours at 450° C. for 12 h under an active flow of air.
The method includes increasing the temperature at a rate of 3° C./min to 10° C./min during calcination and holding the temperature at the maximum temperature for a remaining duration of a calcination time.
The ratio of Li:Mn in step a is greater than 0.8:1 and less than 1:1.

In another aspect, the invention describes a method of preparing a sorbent composition of the formula Li_{1.3-1.6}Mn_{1.6-1.7}O₄ comprising the steps of:
a. mixing solutions of LiOH and MnCl₂ under oxidizing conditions to form a LiMn oxide precipitate; and,
b. separating and drying the LiMn oxide precipitate and calcining the LiMn oxide precipitate to form a calcined Li_{1.3-1.6}Mn_{1.6-1.7}O₄.

In one aspect, the Li_{1.3-1.6}Mn_{1.6-1.7}O₄ is characterized by a crystal structure enabling a reversable exchange of hydrogen and lithium ions within the composition, the sorbent composition effective for selectively concentrating lithium from a lithium brine via an ion exchange process, the crystal structure having a majority of ion exchange sites in relation to redox sites.

In another aspect, the invention describes a method of preparing a sorbent composition of the formula Li_{1.3-1.6}Mn_{1.6-1.7}O₄ comprising the step of:
a. mixing and heating LiOAc and Mn(NO₃)₂ powders with air circulation to dehydrate the powders to form a eutectic LiMn oxide.

In another aspect, the Li_{1.3-1.6}Mn_{1.6-1.7}O₄ powder is characterized by a crystal structure enabling a reversable exchange of hydrogen and lithium ions within the composition, the sorbent composition effective for selectively concentrating lithium from a lithium brine via an ion exchange process, the crystal structure having a majority of ion exchange sites in relation to redox sites.

In another aspect the invention describes a method of concentrating lithium from a lithium-brine, the lithium-brine characterized as having a higher concentration of non-lithium cations relative to lithium cations, the method comprising the steps of:
a. mixing a protonated sorbent composition (PSC) with the lithium brine under conditions to promote ion exchange of lithium within the lithium brine with protons within the PSC;
b. separating the PSC from step a from the lithium brine; and,
c. mixing the PSC from step b with a desorption fluid to desorb lithium from the PSC to the desorption fluid.

In various aspects:
The PSC is a protonated form of a sorbent composition of the formula Li_{1.3-1.6}Mn_{1.6-1.7}O₄
The PSC has a substantially sub-millimeter particle size (less than 1,000 μm, typically less than 100 μm).
The PSC has a substantially micron-particle size, preferably less than 100 μm.
The PSC is calcined in the presence of oxygen prior to step a.
Step a is conducted at pH 7 or higher.
Step c is conducted at pH 6 or lower and the desorption fluid is an acid.
The desorption fluid is sulfuric acid.
The desorption fluid is ammonium persulfate.
Steps a and c are conducted at 15-90° C.
The concentration of lithium in the desorption fluid after step c is greater that 10× the concentration of lithium in the OFB before step a.
The step of separating the desorption fluid from the PSC and repeating steps a to c with the same PSC.
The lithium-brine has a total cation concentration greater than 70,000 mg/L and a lithium cation concentration less than 1000 mg/L.
The lithium cation concentration in the desorption fluid is greater than 500 mg/L.
The lithium cation concentration is greater than 800 mg/L.
The lithium cation concentration is greater than 40 wt % of the total cation concentration in the desorption fluid.
The method as in any one of claims 25-40 wherein the lithium cation concentration is greater than 50 wt % of the total cation concentration in the desorption fluid.
The lithium cation concentration is greater than 60 wt % of the total cation concentration in the desorption fluid.
The desorption fluid has a total cation concentration less than 2000 mg/L and the lithium cation concentration is greater than 500 mg/L.

In another aspect, the invention describes a method of preparing a protonated sorbent composition (PSC) comprising the steps of:
a. mixing LiOH and MnCl₂ under oxidizing conditions to form a LiMn oxide precipitate;
b. separating and drying the LiMn oxide precipitate and calcining the LiMn oxide precipitate to form a calcined LiMn powder; and,
c. mixing the calcined LiMn powder from step b with an acid under conditions to exchange Li within the calcined LiMn powder with protons to form a PSC.

In various aspects:
Step a is conducted in the presence of hydrogen peroxide.
The calcined LiMn powder has a composition Li_{1.3-1.6}Mn_{1.6-1.7}O₄.
The PSC is characterized as having a sub-millimeter particle size.

### BRIEF DESCRIPTION OF THE DRAWINGS

The invention is described with reference to the drawings wherein:

FIG. 1 is a graph showing the mass loss as a function of temperature of a protonated sample (i.e. sorbent) (Sample 1) prepared by a co-precipitation methodology with a Li:Mn ratio of 2.5 and a 12 h calcination time in accordance with one embodiment of the invention.

FIG. 2 is a graph showing the mass loss as a function of temperature of a protonated sample (i.e. sorbent) (Sample 2) prepared by a co-precipitation methodology with a Li:Mn ratio of 3 and a 12 h calcination time in accordance with one embodiment of the invention.

FIG. 3 is a graph showing the mass loss as a function of temperature of a calcined sample (i.e. precursor) (Sample 3) prepared by a solid phase methodology with a Li:Mn ratio of 0.8 and a first 6 hour calcination time at 200° C. followed by a second calcination at 450° C. in accordance with one embodiment of the invention.

FIG. 4 is a graph showing the mass loss as a function of temperature of a protonated sample (i.e. sorbent) (Sample 3) prepared by the solid phase with a Li:Mn ratio of 0.8 and a first 6 hour calcination time at 200° C. followed by a second calcination at 450° C. in accordance with one embodiment of the invention.

FIGS. 5 and 6 are graphs showing XRD analysis for Sample 1 before and after protonation. FIG. 5 shows a 65% match with Li_{1.33}Mn_{1.67}O₄ and 49% match with Li_{1.6}Mn_{1.6}O₄. FIG. 6 shows 88% match with MnO₂.

FIGS. 7 and 8 are graphs showing XRD analysis for Sample 2 before and after protonation. FIG. 7 shows a 61% match with Li_{1.33}Mn_{1.67}O₄ and 72% match with Li_{1.6}Mn_{1.6}O₄. FIG. 8 shows 37% match with MnO₂.

FIGS. 9 and 10 are graphs showing XRD analysis for Sample 3 before and after protonation. FIG. 9 shows a 57% match with Li_{1.33}Mn_{1.67}O₄ and 66% match with Li_{1.6}Mn_{1.6}O₄. FIG. 10 shows a 70% match with MnO₂.

### DETAILED DESCRIPTION OF THE INVENTION

### Introduction and Rationale

The inventors recognized that protonated manganese oxides can be effective as ion exchange media for use in concentrating lithium from various brine solutions containing lithium and other ions. The inventors further recognized that the effectiveness of various ion exchange sorbents is variable and depends on various factors including the stoichiometry of the sorbent compositions as well as the physical structure and functional properties of the sorbents. The inventors also recognized that the ability of a sorbent to be used repeatedly as an ion exchange media is related to the chemical and physical properties of the sorbents.

### Terminology

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof. As used herein, the term “and/or” includes any and all combinations of one or more of the associated listed items.

Other than described herein, or unless otherwise expressly specified, all of the numerical ranges, amounts, values and percentages, such as those for amounts of materials, elemental contents, times and temperatures, ratios of amounts, and others, in the following portion of the specification and attached claims may be read as if prefaced by the word “about” even though the term “about” may not expressly appear with the value, amount, or range. Accordingly, unless indicated to the contrary, the numerical parameters set forth in the following specification and attached claims are approximations that may vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Unless otherwise defined, all technical and scientific terms used herein have the same meaning as commonly understood by one of ordinary skill in the art to which this invention belongs.

Various aspects of the invention will now be described with reference to the figures. The invention may, however, be embodied in many different forms and should not be construed as limited to the embodiments set forth herein; rather, these embodiments are provided so that this disclosure will be thorough and complete, and will fully convey the scope of the invention to those skilled in the art.

In its broadest form, the invention describes sorbent compositions (SCs) of the formula Li_{1.3-1.6}Mn_{1.6-1.7}O₄ having a crystal structure enabling reversable ion exchange of lithium and hydrogen within the composition. The SCs are synthesized in a lithiated form, and thereafter processed in acid to exchange lithium with hydrogen to form protonated sorbent compositions (PSCs) for subsequent use as an ion exchange media for concentrating lithium from brines.

In one aspect, the invention describes a sorbent composition (SC) of the formula Li_{1.3-1.6}Mn_{1.6-1.7}O₄ having a crystal structure enabling a reversable exchange of hydrogen and lithium ions within the composition, the sorbent composition effective for selectively concentrating lithium from a lithium brine via an ion exchange process, the crystal structure having a majority of ion exchange sites in relation to redox sites.

In various aspects:
The crystal structure has a ratio of ion exchange sites to redox sites greater than 2:1.
The crystal structure has a ratio of ion exchange sites to redox sites greater than 5:1.
The crystal structure has a ratio of ion exchange sites to redox sites greater than 15:1.
The composition has an average oxidation state greater than 3.8.
The sorbent composition is in a protonated form.

In another aspect, the invention describes a sorbent composition prepared by a co-precipitation process comprising the steps of:
a. Mixing LiOH and MnCl₂ under oxidizing conditions to form a LiMn oxide precipitate; and,
b. Separating and drying the LiMn oxide precipitate and calcining the LiMn oxide precipitate to form a calcined LiMn oxide powder.

In various aspects:
Step b includes calcining at a temperature from 100° C. to 450° C.
Step b includes increasing the temperature at a rate of 10° C./min during calcination and holding the temperature at the maximum temperature for a remaining duration of a calcination time.
Step b includes maintaining an air flow through the LiMn oxide powder during calcination.
The calcination time is greater than 6 hours.
Step a is conducted in the presence of hydrogen peroxide.
The sorbent is converted to a protonated form by mixing the calcined LiMn powder oxide from step b with an acid under conditions to exchange Li within the calcined LiMn powder with protons to form a protonated sorbent composition (PSC).
The method includes the step of drying the PSC and wherein the PSC is characterized as having a sub-millimeter particle size.
The ratio of Li:Mn in step a is greater than 2:1 and less than 3:1.

In another aspect, the invention describes a sorbent composition prepared by a solid phase process comprising the step of:
a. mixing and heating LiOAc and Mn(NO₃)₂ powders with air circulation to dehydrate the powders to form a eutectic LiMn oxide powder.

In various aspects:
Step a includes heating to 100° C.
The method includes a step of first calcining the LiMn oxide powder for >6 hours at 200° C. under an active flow of air.
The method includes a step of repeating calcining the LiMn oxide powder for >6 hours at 450° C. for 12 h under an active flow of air.
The ratio of Li:Mn in step a is greater than 0.8:1 and less than 1:1.

In another aspect, the invention describes a method of preparing a sorbent composition of the formula Li_{1.3-1.6}Mn_{1.6-1.7}O₄ comprising the steps of:
a. mixing solutions of LiOH and MnCl₂ under oxidizing conditions to form a LiMn oxide precipitate; and,
b. separating and drying the LiMn oxide precipitate and calcining the LiMn oxide precipitate to form a calcined Li_{1.3-1.6}Mn_{1.6-1.7}O₄.

In one aspect, the Li_{1.3-1.6}Mn_{1.6-1.7}O₄ is characterized by a crystal structure enabling a reversable exchange of hydrogen and lithium ions within the composition, the sorbent composition effective for selectively concentrating lithium from a lithium brine via an ion exchange process, the crystal structure having a majority of ion exchange sites in relation to redox sites.

In another aspect, the invention describes a method of preparing a sorbent composition of the formula Li_{1.3-1.6}Mn_{1.6-1.7}O₄ comprising the step of:
a. mixing and heating LiOAc and Mn(NO₃)₂ powders with air circulation to dehydrate the powders to form a eutectic LiMn oxide.

In another aspect, the Li_{1.3-1.6}Mn_{1.6-1.7}O₄ powder is characterized by a crystal structure enabling a reversable exchange of hydrogen and lithium ions within the composition, the sorbent composition effective for selectively concentrating lithium from a lithium brine via an ion exchange process, the crystal structure having a majority of ion exchange sites in relation to redox sites.

In another aspect the invention describes a method of concentrating lithium from a lithium-brine the lithium-brine characterized as having a higher concentration of non-lithium cations relative to lithium cations, the method comprising the steps of:
a. mixing a protonated sorbent composition (PSC) with the lithium brine under conditions to promote ion exchange of lithium within the lithium brine with protons within the PSC;
b. separating the PSC from step a from the lithium brine; and,
c. mixing the PSC from step b with a desorption fluid to desorb lithium from the PSC to the desorption fluid.

In various aspects:
The PSC is a protonated form of a sorbent composition of the formula Li_{1.3-1.6}Mn_{1.6-1.7}O₄
The PSC has a substantially sub-millimeter particle size (less than 1000 μm, typically less than 100 μm).
The PSC has a substantially micron-particle size, preferably less than 100 μm.
The PSC is calcined in the presence of oxygen prior to step a.
Step a is conducted at pH 7 or higher.
Step c is conducted at pH 6 or lower and the desorption fluid is an acid.
The desorption fluid is sulfuric acid.
The desorption fluid is hydrochloric acid.
The desorption fluid is ammonium persulfate.
Steps a and c are conducted at 15-90° C.
The concentration of lithium in the desorption fluid after step c is greater that 10× the concentration of lithium in the OFB before step a.
The step of separating the desorption fluid from the PSC and repeating steps a to c with the same PSC.
The lithium-brine has a total cation concentration greater than 70,000 mg/L and a lithium cation concentration less than 1000 mg/L.
The lithium cation concentration in the desorption fluid is greater than 500 mg/L.
The lithium cation concentration is greater than 800 mg/L.
The lithium cation concentration is greater than 40 wt % of the total cation concentration in the desorption fluid.
The method as in any one of claims 25-40 wherein the lithium cation concentration is greater than 50 wt % of the total cation concentration in the desorption fluid.
The lithium cation concentration is greater than 60 wt % of the total cation concentration in the desorption fluid.
The desorption fluid has a total cation concentration less than 2000 mg/L and the lithium cation concentration is greater than 500 mg/L.

In another aspect, the invention describes a method of preparing a protonated sorbent composition (PSC) comprising the steps of:
a. mixing LiOH and MnCl₂ under oxidizing conditions to form a LiMn oxide precipitate;
b. separating and drying the LiMn oxide precipitate and calcining the LiMn oxide precipitate to form a calcined LiMn powder; and,
c. mixing the calcined LiMn powder from step b with an acid under conditions to exchange Li within the calcined LiMn powder with protons to form a PSC.

In various aspects:
Step a is conducted in the presence of hydrogen peroxide.
The calcined LiMn powder has a composition Li_{1.3-1.6}Mn_{1.6-1.7}O₄.
The PSC is characterized as having a sub-millimeter particle size.

### Chemical Composition and Reaction Theory

Without being bound to any particular theory, the inventors synthesized sorbent compositions useful as effective ion exchange media for concentrating lithium from brines. The sorbent structures are characterized as having a high proportion of ion exchange sites relative to redox sites within the crystal structures. The inventors postulated that structures having a high ratio of ion exchange to redox sites would enhance both the effectiveness of the sorbent in enabling proton/lithium exchange (sorption and desorption) and also the repeatability of the proton/lithium exchange across multiple ion exchange cycles.

The stoichiometry of a particular composition is not inherently indicative of a uniform crystal structure and/or its effectiveness as an ion exchange media. As such, compositions synthesized may have different structures including structures supporting ion exchange and redox reactions. As discussed below, crystal structures having a preponderance of ion exchange sites are characterized by a higher average oxidation number whereas crystal structures have a preponderance of redox sites are characterized by a lower oxidation number.

The chemistry of redox and ion exchange reactions for both sorption and desorption in Li/H Mn oxide structures are summarized below.

1.1. Redox Reaction During Sorption

$$( □ ) [ {Mn}_{2}^{I V} ] {O}_{4} + n LiOH \to ( {Li}_{n} {□}_{1 - n} ) [ {Mn}_{n}^{III} {Mn}_{2 - n}^{IV} ] {O}_{4} + \frac{n}{2} {H}_{2} O + \frac{n}{4} {O}_{2} \qquad ( eq . 1 )$$

1.2. Redox Reaction During Desorption

Mn(III)-R—O—Li+2H⁺→Mn(IV)-R+Li⁺+e⁻+H₂O (eq. 2)

Mn(IV)-R+2e⁻→Mn(II)+R (eq. 3)

1.3. Ion Exchange During Sorption

Mn(IV)-R—O—H+Li⁺→Mn(IV)-R—O—Li+H⁺ (eq. 4)

1.4. Ion Exchange During Desorption

Mn(IV)-R—O—Li+H⁺→Mn(IV)-R—O—H+Li⁺ (eq. 5)

From the above and experimental results, it has been determined that the desirable target ion exchange (IX) precursor sorbent compositions (SCs) are Li_{1.3-1.6}Mn_{1.6-1.7}O₄ and undesirable redox precursor compositions are LiMn₂O₄. As such, the corresponding target protonated sorbent compositions (PSCs) are H_{1.3-1.6}Mn_{1.6-1.7}O₄ and the undesirable redox sorbents are λ-MnO₂.

Determination of the relative presence/absence of these target and undesirable precursors and sorbents are accordingly indicative of the effectiveness and stability of the sorbents as ion exchange media in that sorbent compositions having structures with a preponderance of ion exchange sites will be more effective in repeatedly exchanging protons/lithium through multiple cycles.

Various methods of precipitation, hydrothermal and solid phase reaction for the creation of sorbents have been followed in the past. However, understanding and developing compositions having a substantially consistent and desirable crystal structure that has improved ion exchange performance hereto before has not been well understood.

### Sorbent Compositions (SCs) and Processes of Manufacture

Lithium sorbent compositions (SCs) of the general formula Li_{1.3-1.6}Mn_{1.6-1.7}O₄ were synthesized via co-precipitation and solid-phase processes. The SCs are subsequently treated with acid to exchange lithium with hydrogen to form protonated sorbent compositions (PSCs) effective for lithium concentration via ion exchange.

### Co-Precipitation Process

In a first embodiment, SCs are synthesized by a co-precipitation process.

Step 1—Oxidize MnCl₂ and form LiMn oxide powder

An aqueous solution of manganese (II) chloride is oxidized in the presence of lithium hydroxide at a pH higher than 8 and preferably higher than 11 to form a suspension of a LiMn oxide in water. Preferably the starting ratio of Li:Mn is 2-4:1 and the oxidation reaction is enhanced by adding stoichiometric amounts of hydrogen peroxide. Preferably, hydrogen peroxide (30% w/w) is added at a 1:1 ratio relative to Mn. After sufficient reaction time, the mixture is dried to form a fine powder of LiMn oxide and calcined (in the presence of oxygen) to produce LiMn oxides having a formulation of Li_{1.3-1.6}Mn_{1.6-1.7}O₄.

### Step 2—Exchange Li for H and Form PSC

The calcined powder from Step 1 is suspended in an acid to desorb the Li through ion exchange where the Li is exchanged for protons thus forming a suspension of HMn oxide (i.e. the PSC) based on the SC formulation Li_{1.3-1.6}Mn_{1.6-1.7}O₄. The suspension is centrifuged to separate the acid/Li solution from the PSC and the centrifuged suspension is dried, suspended in water and dried again to form a PSC powder.

### Synthesis Example—Co-Precipitation (Li:Mn=3)

### Example 1

Protonated manganese oxide sorbent was synthesized by a co-precipitation method at a 20-g scale.

MnCl₂·4H₂O (150 mmol) was dissolved in 400 mL deionized water at room temperature while stirring at 270 rpm using an IKA RW20 Digitals overhead stirrer. The pH was monitored using an 8102BNUWP ROSS ultra-combination pH probe with Orin 5-star pH benchtop control. The expected pH for the solution is between 4.7 and 5.3. The temperature of the solution was monitored using a temperature probe.

Anhydrous LiOH (450 mmol) was dissolved in 150 mL of deionized water using a magnetic stir bar. The LiOH solution was then added slowly (using a plastic pipette) to the MnCl₂ solution at room temperature while monitoring the pH and stirring the solution. Mn(OH)₂ precipitates at ˜pH 8.5 and creates a milky suspension. After complete addition of the LiOH solution, the pH is higher than 11.2. At that point, 15 mL of H₂O₂ (30%) was added to the suspension using a peristaltic pump with flow rate of ˜3.3 mL/min while monitoring the temperature and pH. The temperature was kept below 30° C. using a cool water bath. Upon full addition of the H₂O₂, the final pH is typically 12.5 and a black precipitate of manganese oxide is formed. The suspension was covered and stirred for two hours at room temperature before being transferred to a glass tray and dried in a convection oven at 90° C. for a couple of days.

The dried sample was ground using a porcelain mortar and pestle to a fine powder and transferred to an alumina crucible which was placed in a furnace for multiple calcinations at 450° C. under active 1000 mL/min flow of air with heating/cooling ramp rate of 3° C./min with grinding steps (3 steps for 12 hour calcination and 4 grinding steps for 24 hour calcination) between calcination steps. The total calcination time was either 12 or 24 hours.

After calcination, the sample was washed with DI water to remove excess LiOH and LiCl present in the sample. The sample was then separated via centrifuging at 4000 g for 2 min followed by addition of water and another centrifuging at the same condition.

To exchange lithium in the sorbent with protons, calcined sorbent was stirred in 0.5 M sulfuric acid with a ratio of 10 g/L at room temperature for 1 hour. The protonated sample was then separated via centrifuging at 4000 g for 2 min followed by addition of water and centrifuging at the same condition. Addition of water and centrifuging was repeated one more time before the protonated sorbent was dried at 40° C. overnight.

### Synthesis Example—Co-Precipitation (Li:Mn=2.5)

### Example 2

Protonated manganese oxide sorbent was synthesized by a co-precipitation method at a 20-g scale.

MnCl₂·4H₂O (150 mmol) was dissolved in 400 mL deionized water at room temperature while stirring at 270 rpm using an IKA RW20 Digitals overhead stirrer. The pH was monitored using an 8102BNUWP ROSS ultra-combination pH probe with Orin 5-star pH benchtop control. The expected pH for the solution is between 4.7 and 5.3. The temperature of the solution was monitored using a temperature probe.

Anhydrous LiOH (375 mmol) was dissolved in 125 mL of deionized water using a magnetic stir bar. The LiOH solution was then added slowly (using a plastic pipette) to the MnCl₂ solution at room temperature while monitoring the pH and stirring the solution. Mn(OH)₂ precipitates at ˜pH 8.5 and creates a milky suspension. After complete addition of the LiOH solution, the pH is higher than 11.2. At that point, 15 mL of H₂O₂ (30%) was added to the suspension using a peristaltic pump with flow rate of ˜3.3 mL/min while monitoring the temperature and pH. The temperature was kept below 30° C. using a cool water bath. Upon full addition of the H₂O₂, the final pH is typically 12.5 and a black precipitate of manganese oxide is formed. The suspension was covered and stirred for two hours at room temperature before being transferred to a glass tray and dried in a convection oven at 90° C. for a couple of days.

The dried sample was ground using a porcelain mortar and pestle to a fine powder and transferred to an alumina crucible which was placed in a furnace for multiple calcinations at 450° C. under active 1000 mL/min flow of air with heating/cooling ramp rate of 3° C./min with grinding steps (3 steps for 12 hour calcination and 4 grinding steps for 24 hour calcination) between calcination steps. The total calcination time was either 12 or 24 hours.

After calcination, the sample was washed with DI water to remove excess LiOH and LiCl present in the sample. The sample was then separated via centrifuging at 4000 g for 2 min followed by addition of water and another centrifuging at the same condition.

To exchange lithium in the sorbent with protons, calcined sorbent was stirred in 0.5 M sulfuric acid with a ratio of 10 g/L at room temperature for 1 hour. The protonated sample was then separated via centrifuging at 4000 g for 2 min followed by addition of water and centrifuging at the same condition. Addition of water and centrifuging was repeated one more time before the protonated sorbent was dried at 40° C. overnight.

### Solid Phase Process

In a second embodiment, PSCs are formed via solid phase synthesis processes. For solid phase process Li:Mn of 0.8-1.0 are preferred during synthesis.

Step 1—Mix LiOAc and Mn(NO₃)₂

LiOAc dihydrate and Mn(NO₃)₂ tetrahydrate powders are mixed and heated with air circulation to dehydrate the reagents as follows:

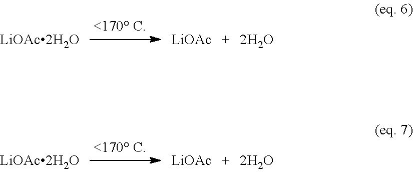

### Step 2—Calcination

After dehydration, the eutectic mixture is cooled and subsequently calcined with air circulation to form a LiMnO powder having the general formula Li_{1.3-1.6}Mn_{1.6-1.7}O₄ as follows:

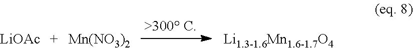

### Step 3—Acid Treatment

After calcination, the LiMnO powder was acid treated to exchange Li for H and form the PSC powder.

### Synthesis Example—Solid Phase (Li:Mn=0.8)

### Example 1

Protonated manganese oxide (20 g scale) was synthesized using the solid-phase process.

LiOAc·2H₂O (160 mmol) and Mn(NO₃)₂·4H₂O (200 mmol) were transferred into a 500-mL separable flask and mixed at 100° C. for 2 h with stirring under 1000 mL/min flow of air. The heating and stirring were done using a hot plate and a heat-on block and a 1-inch egg-shaped magnetic stir bar. The temperature was monitored using a temperature probe.

At around 50° C., the mixture starts to melt slowly resulting in a light pink colored solution and around 100° C. the water present in the starting materials starts to condense and the solution turns brown. After 1-2 hours, the solution was transferred into an alumina crucible and dried in a convection oven at 60° C. for a couple of hours before the crucible was transferred to a furnace for calcination at 200° C. for 6 hours under an active 1000 mL/min flow of air. The sample was then ground using a mortar and pestle prior to subjecting the powder to a second calcination at 450° C. for 12 h under an active flow of air (1000 mL/min). The heating and cooling ramp rate used with the furnace is 3° C./min.

To exchange lithium in the sorbent with protons, the calcined sorbent was stirred in 0.5 M sulfuric acid with a ratio of 10 g/L at room temperature for 1 hour. The protonated sample was then separated via centrifuging at 4000 g for 2 min followed by addition of water and centrifuging at the same condition. Addition of water and centrifuging was repeated one more time before the protonated sorbent was dried at 40° C. overnight.

### PSC Synthesis

As noted above, it is desirable to obtain a sorbent that dominantly operates by ion exchange with minimal or reduced Mn loss during Li extraction. Factors affecting Mn loss during ion exchange include the initial Li:Mn ratio during PSC synthesis, controlling calcination time and temperature and active airflow during calcination.

### Initial Li:Mn Ratio

The initial Li:Mn ratio during synthesis affects the number and stability of ion exchange sites. For the co-precipitation method, the preferred ratio is 2.2-3.0 and for the solid phase method 0.8-1.0.

For example, mixing LiOH and MnCl₂ at a ratio of 3 during PSC synthesis results in ˜0.5% (or less) loss of Mn during Li/H exchange during lithium extraction from the brine. In this case, lithium uptake during brine treatment was between −10 to 35 mg of Li per gram of sorbent. Importantly, this initial ratio may affect the formation of defects in the crystal structure of the manganese dioxide which creates sites for Li diffusion into the crystal structure. More specifically, the LiOH:MnCl₂ ratio during synthesis is understood to control the relative number of octahedral sites of the crystal which are the sites for Li diffusion. Moreover, the relative oxidation of Mn during synthesis may also affect the appearance of impurities within the crystal structure which will also affect the number and stability of the octahedral sites of the crystal as determined by X-ray diffraction. In various syntheses, it was understood that the use of a strong oxidizing agent, such as hydrogen peroxide, increases the proportion of Mn promoted from 2+ to 4+ which increases the number of octahedral sites.

As determined experimentally, the Li_{1.3-1.6}Mn_{1.6-1.7}O₄ formulations having a higher average oxidation state provide improved ion exchange within a stable crystal. However, increased Li:Mn within the crystal, while still an ion exchange media is understood to have fewer or less binding sites and, hence decreased lithium uptake performance. In addition, the Li:Mn within the crystal may also affect the Mn loss during Li exchange.

### Calcination Time

Sorbents prepared with both an increased calcination time (>6 h and preferably >12 h) and lithium: manganese ratios (2.2-3.0 for co-precipitation and 0.8-1.0 for solid phase) resulted in reduced sorbent degradation. The introduction of active air flow and intermittent grinding improves consistency in the co-precipitation sorbent synthesis wherein an air flow of 1000 mL/min and grinding/mixing of the sorbent powders every 2-3 hours were effective.

### Other Reagents

Other reagents were used for co-precipitation and solid phase methods including manganese chloride, manganese nitrate, manganese oxide, lithium acetate, and lithium hydroxide for both synthesis methods and hydrogen peroxide for the co-precipitation method.

### PSC Characterization

### Experimental and Results

Table 1 shows different samples subjected to analysis.

TABLE 1
Samples and Methods of Preparation

| | | Calcination | |
|---|---|---|---|
| Sample | Method | Time | Li:Mn Ratio |
| 1 | Co-Precipitation | 12 h@450° C. | 2.5 |
| 2 | Co-Precipitation | 12 h@450° C. | 3 |
| 3 | Solid Phase | 6 h@200° C. | 0.8 |
| | | 12 h@400° C. | |

### Thermogravimetric Analysis (TGA)

TGA analysis was undertaken to quantify the desired IX and undesired redox sites within the precursors and sorbents. Generally, if the sites are IX, the Li uptake will remain the same and Mn loss during desorption will be minimal. In contrast, if the sites are pure redox the lithium uptake should approach zero in the next cycle as it is known Li ions do not resorb to original redox sites (Chem. Mater., Vol. 12, No. 10, 2000).

For lithiated sorbent compositions (LSCs), no mass loss should be observed. After protonation, (i.e. after acid treatment of the precursors to form the PSCs), if the desired IX sites are present within the crystals, dehydration of OH groups will result in a 9.3% mass loss according to:

5 H_{1.6}Mn_{1.6}O₄₍ₛ₎→8 MnO₂ (s)+4 H₂O_{(g)} (eq. 9)

In comparison, the presence of redox sorbent λ-MnO₂ would result in no mass loss as there would be no OH groups present.

If the process is 100% redox, the molar ratio of Mn:Li in the protonation acid should be close to 0.5.

Thermogravimetric analysis (TGA) was carried out using a Metter Toledo Thermogravimetric Analysis/Differential Scanning calorimeter 1 (TGA/DSC1) STAR System. The analysis on the calcined material was performed under an atmosphere of air (temperature range of 25-1000° C., heating rate=10° C./min). The analysis on the protonated material was performed under nitrogen (temperature range of 25-450° C. (and to 1000° C. for destructive analysis), heating rate=10° C./min; hold at 105° C. for 10 min to avoid absorbed water interference).

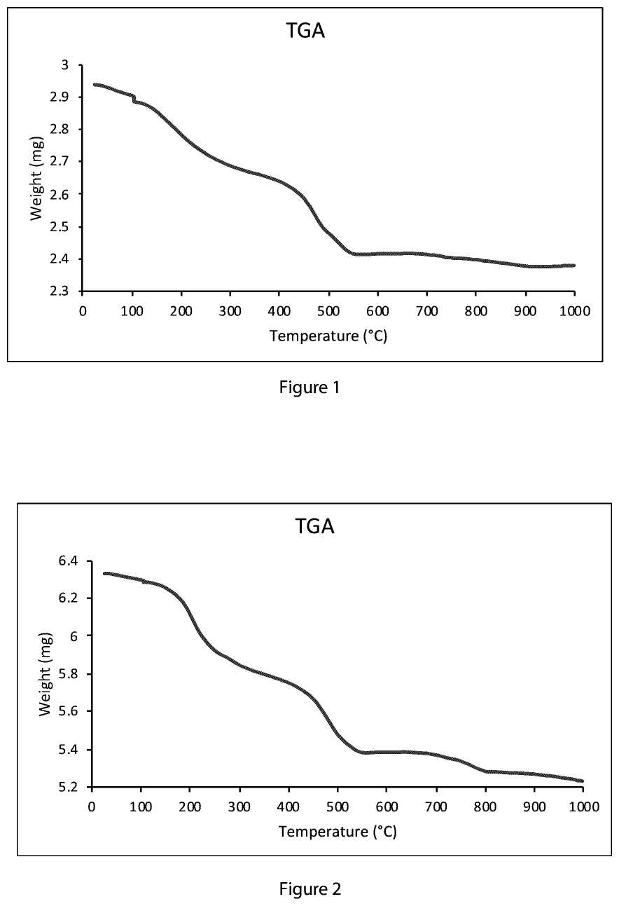

FIG. 1 (Sample 1) shows the mass loss as a function of temperature of a protonated (i.e. sorbent) sample prepared by co-precipitation with a Li:Mn ratio of 2.5 and a 12 h calcination time. FIG. 1 shows a 9.10% mass loss between 150° C. and 400° C. which indicates the presence of ion exchange sites due to the dehydration of OH groups.

FIG. 2 (Sample 2) shows the mass loss as a function of temperature of a protonated (i.e. sorbent) sample prepared by the co-precipitation method with a Li:Mn ratio of 3 and a 12 h calcination time. FIG. 2 shows a 9.81% mass loss between 150° C. and 400° C. which indicates presence of ion exchange sites due to the dehydration of OH groups.

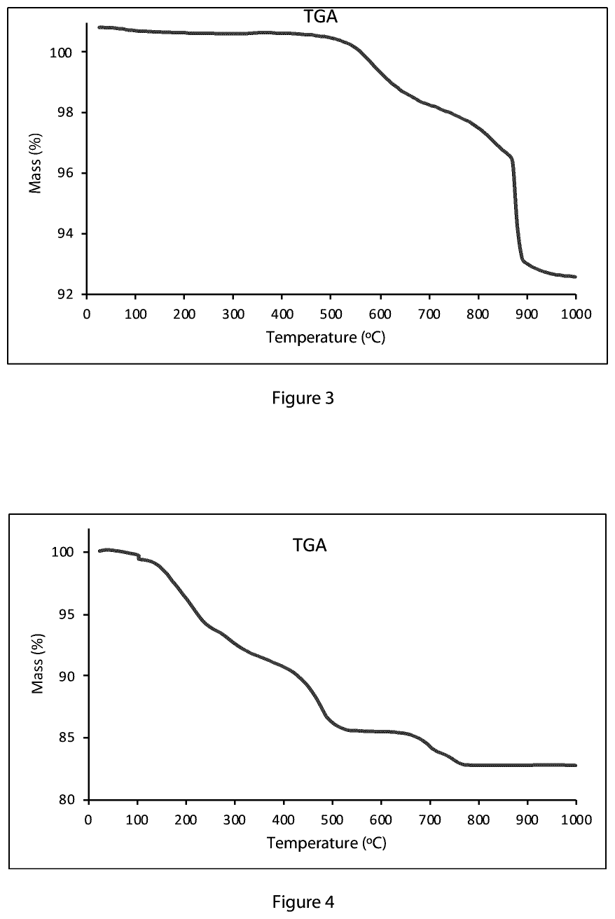

FIG. 3 (Sample 3) shows the mass loss as a function of temperature of a calcined (i.e. precursor) sample prepared by the solid phase method with a Li:Mn ratio of 0.8 and a first 6 hour calcination time at 200° C. followed by a second calcination at 450° C. FIG. 3 shows no mass loss between 150° C. and 400° C., which indicates the absence of ion exchange sites due to the lack of dehydration of OH groups.

FIG. 4 (Sample 3) shows the mass loss as a function of temperature of a protonated (i.e. sorbent) sample prepared by the solid phase with a Li:Mn ratio of 0.8 and a first 6 hour calcination time at 200° C. followed by a second calcination at 450° C. FIG. 4 shows a 9.57% mass loss between 150° C. and 400° C. indicates presence of ion exchange sites due to the dehydration of OH groups.

### Average Oxidation State Analysis

A pure precursor of IX media should have oxidation state of 4 meaning all Mn are present as Mn⁴⁺. Similarly, a pure protonated IX media should have oxidation state of 4 meaning all Mn are still Mn⁴⁺ after acid treatment.

In comparison, a pure precursor of redox sorbent should have oxidation state of 3.5 meaning half of the Mn are Mn³⁺ and the other half are Mn⁴⁺ and a pure protonated redox sorbent should have oxidation state of 4 meaning all Mn are Mn⁴⁺ after acid treatment and Mn³⁺ have been converted to Mn²⁺ and lost during Li desorption.

### Oxidation State Methodology

Oxidation state measurement of calcined and protonated sorbents was completed using procedures from the following references: Japan Industrial Standard (JIS), M8233, 1969.; J. Phys. Chem. A 2004, 108, 11026-11031; and, Analyst, December 1971, Vol. 96, pp. 865-869.

### Solution Preparation

A 0.1M sodium oxalate solution was prepared by adding 0.1 moles of solid sodium oxalate to 500 mL of deionized water. To that, 45 mL of concentrated sulfuric acid was added and the resulting solution was diluted with deionized water to yield 1 L of total solution volume.

A 0.01M potassium permanganate solution was prepared by adding 0.01 moles of solid KMnO₄ to 1 L of deionized water.

To standardize solutions, 15 mL of 0.1 M sodium oxalate solution was transferred into 3 separate vials (5 mL each) followed by addition of 2.5 mL of 4 M sulfuric acid into each vial. The vials were heated to 80° C. while stirring after which the solutions were diluted by adding 7.5 mL of hot water (80° C.) to each vial. The solutions were titrated with 0.01 M potassium permanganate solution to obtain a persistent faint pink endpoint. The volume of potassium permanganate solution needed to reach that point was recorded and averaged.

Average oxidation state (AOS) measurement was completed using the following steps:

180 mg of either the calcined or protonated sorbent was weighed out into a beaker. To the sorbent, 25 mL of the 0.1 M oxalate solution and 12.5 mL of 4 M sulfuric acid were added. The resulting solution was heated to 80° C. and was kept at that temperature until a clear solution is obtained. The solution was then diluted with 37.5 mL of hot water (at 80° C.) and titrated with 0.01 M potassium permanganate solution. The amount of potassium permanganate solution needed to reach a persistent faint pink endpoint was recorded. Using this data, the average oxidation state for the sorbent is determined.

Using the AOS data and the Li:Mn ratio obtained through ICP analysis, the structure formula for the calcined sorbent is determined.

Tables 2 and 3 show the AOS results for calcined (i.e. precursor) and protonated (i.e. sorbent) compositions prepared by co-precipitation and Table 4 shows the AOS results for compositions prepared by solid phase. All samples showed high AOS values indicating a high number of IX sites.

TABLE 2
AOS and Structure Formula-Co-Precipitation

| | Li:Mn | | |
|---|---|---|---|
| Sample 1 | ratio | AOS | Formula |
| Calcined | 0.66 | 3.69 | Li_{1.22}Mn_{1.84}O₄ |
| Protonated | 0.01 | 3.83 | |

[Mn]:[Li] in protonation liquid = 0.14

TABLE 3
AOS and Structure Formula-Co-Precipitation

| | Li:Mn | | |
|---|---|---|---|
| Sample 2 | ratio | AOS | Formula |
| Calcined | 0.92 | 3.84 | Li_{1.55}Mn_{1.68}O₄ |
| Protonated | 0.1 | 3.99 | |

[Mn]:[Li] in protonation liquid = 0.02

TABLE 4
AOS and Structure Formula-Solid Phase

| | Li:Mn | | |
|---|---|---|---|
| Sample 3 | ratio | AOS | Formula |
| Calcined | 0.82 | 3.92 | Li_{1.39}Mn_{1.69}O₄ |
| Protonated | 0.03 | 3.91 | |

[Mn]:[Li] in protonation liquid = 0.05

### Particle Size Analysis

PSCs were examined under Scanning Electron Microscope (SEM) and observed that particles were sub-millimeter in size.

### X-Ray Diffraction (XRD) Analysis

Analysis of crystal structure was conducted via XRD analysis wherein the presence of IX precursors/sorbents through protonation/de-protonation cycles would be shown by unchanged XRD patterns obtained at different cycles. In comparison, the presence of redox precursors/sorbents would result in a decrease in the lattice constant after Li desorption.

Powder X-ray diffraction (XRD) analysis was carried out using a Panalytical X'pert Pro Powder diffractometer with Co Kα radiation (λ=1.78901 Å) at 40 kV and 45 mA, scanning from 4° to 90°. Panalytical High Score Plus software was used to analyze XRD data. The samples were ground using a mortar and pestle for few seconds to obtain a fine powder prior to analysis. Sample deposition was done using flat-plate method in which more sample powder is filled up in hollow space of an aluminum sample holder. To avoid vertical loading, excess powder is removed using a razor blade

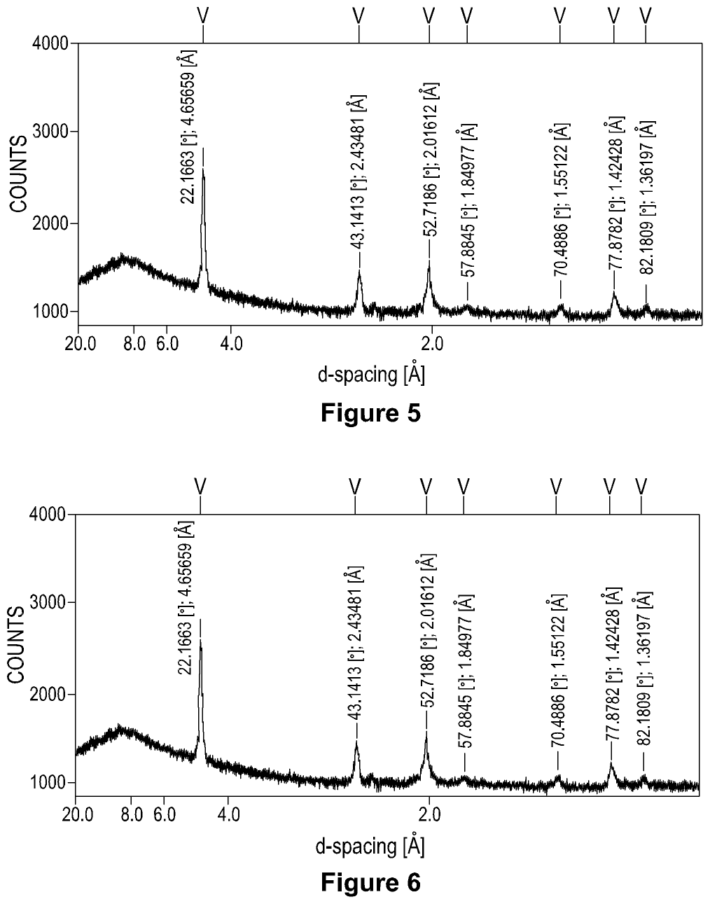

FIGS. 5 and 6 show XRD analysis for Sample 1 before and after protonation. FIG. 5 shows a 65% match with Li_{1.33}Mn_{1.67}O₄ and 49% match with Li_{1.6}Mn_{1.6}O₄. FIG. 6 shows 88% match with MnO₂.

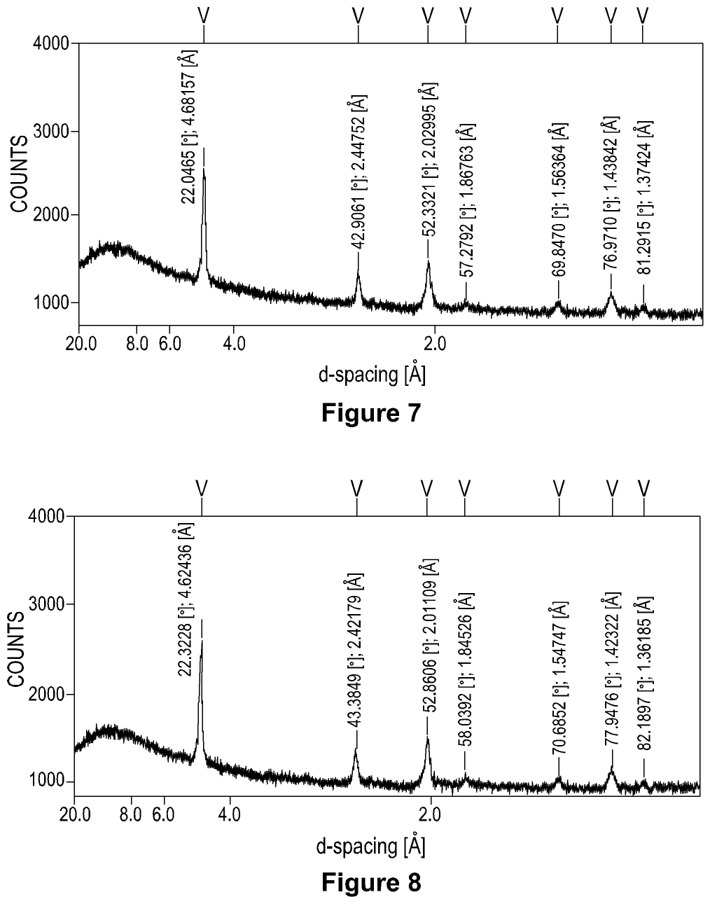

FIGS. 7 and 8 show XRD analysis for Sample 2 before and after protonation. FIG. 7 shows a 61% match with Li_{1.33}Mn_{1.67}O₄ and 72% match with Li_{1.6}Mn_{1.6}O₄. FIG. 8 shows 37% match with MnO₂.

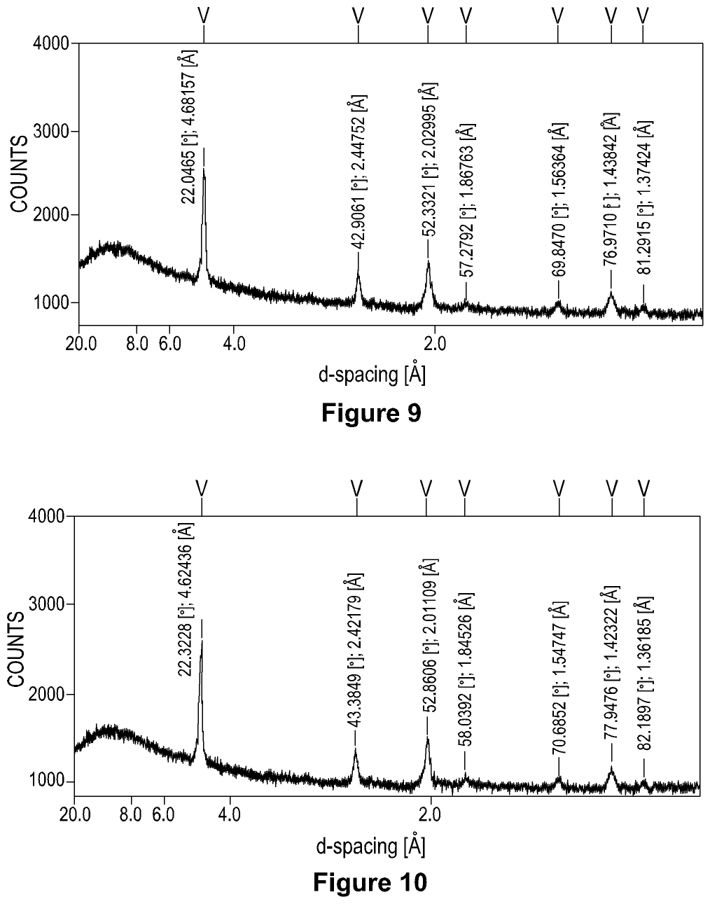

FIGS. 9 and 10 show XRD analysis for Sample 3 before and after protonation. FIG. 9 shows a 57% match with Li_{1.33}Mn_{1.67}O₄ and 66% match with Li_{1.6}Mn_{1.6}O₄. FIG. 10 shows a 70% match with MnO₂.

Importantly, the XRD patterns reveal that the precursors have a spinel structure of LiMnO after calcination and that the spinel structure is stable after protonation and that that the samples are absent of impurity phases like Mn₂O₃. In addition, the different synthetic pathways using different reagents result in the same spinel structure without impurities and shifts in peaks positions.

### Ratio of IX to Redox Sites

From the above, the IX:redox site ratio was calculated for the 3 samples and are summarized in Table 5.

TABLE 5
Ion Exchange to Redox Site Ratio

| | | Based | Based on |
|---|---|---|---|
| | | on AOS | [Mn]:[Li] |
| | | (theo- | exper- |
| Sample | | retical | imental |
| 1 | | | |
| AOS: 3.67 | | | |
| Li_{1.22}Mn_{1.84}O₄, | | | |
| [Mn]:[Li] = 0.14 | | | |
| Redox Fraction | Li_{0.6}Mn(III)_{0.6} Mn(IV)_{0.6}O_{2.4} | 50% | 34% |
| IX Fraction | Li_{0.6}Mn(IV)_{0.65}O_{1.6} | 34% | 66% |
| Ratio (IX:R) | | | 2:1 |
| 2 | | | |
| AOS: 3.84 | | | |
| Li_{1.55} Mn_{1.68} O₄, | | | |
| [Mn]:[Li] = 0.02 | | | |
| Redox Fraction | Li_{0.27}Mn(III)_{0.27}Mn(IV)_{0.27}O_{1.08} | 17.5% | 6% |
| IX Fraction | Li_{1.28}Mn(IV)_{1.12}O_{2.92} | 82.5% | 94% |
| Ratio (IX:R) | | | 15.6:1 |
| 3 | | | |
| AOS: 3.92 | | | |
| Li_{1.39} Mn_{1.69} O₄, | | | |
| [Mn]:[Li] = 0.05 | | | |
| Redox Fraction | Li_{0.14}Mn(III)_{0.14}Mn(IV)_{0.14}O_{0.56} | 10% | 14% |
| IX Fraction | Li_{1.25}Mn(IV)_{1.41}O_{3.44} | 90% | 86% |
| Ratio (IX:R) | | | 6.1:1 |

### Brine Processing and Lithium Concentration Process

The PSC as described above is effective in selectively and reversibly exchanging dissolved lithium for protons within a PSC/brine mixture utilizing the following generalized steps of Li adsorption and PSC regeneration:

### Step A—Li Adsorption

Powdered PSC is mixed with brine at 15-90° C. (preferred 60-90° C.) at pH 7-10 (preferably 8) and allowed to equilibrate. During this step, lithium exchanges for protons within the PSC.

After equilibrium is attained, the Li-loaded sorbent is centrifuged at 4000 g for 5 min followed by a deionized water wash (×2) as described above thus forming a Li-loaded sorbent powder.

### Step B—Li Release and PSC Regeneration

The Li-loaded sorbent powder is dispersed in 0.1-1 M desorbent at 20-70° C. to regenerate the PSC and exchange lithium ions to the desorbent. Desorbents include but are not limited to sulfuric acid, hydrochloric acid, sodium persulfate, and ammonium persulfate. After desorption, the regenerated sorbent can be dried and reused.

The Li-loaded acid is thus enriched in Li relative to other cations and as compared to the original brine.

Steps A and B can be repeated across multiple cycles.

### Examples and Results

In a first example, 400 mg of sorbent was suspended in 200 mL of brine at pH 8 and 70° C. for 1 hour. The brine contained 79 mg/L Li, 280 mg/L B, 46860 mg/L Na, 3386 mg/L Mg, 6360 mg/L K, 20560 mg/L Ca, and 870 mg/L Sr (all analyses using an ICP-OES). After sorption, the sorbent was dispersed in 10 mL 0.5 M sulfuric acid at room temperature for an hour. The lithium concentration in the desorbent was 1498 mg/L while concentration of other major solutes was as follows: 13 mg/L B, 76 mg/L Na, 114 mg/L Mg, 7 mg/L K, 321 mg/L Ca, 30 mg/L Sr, and 379 mg/L Mn (lost from the sorbent). The lithium extraction efficiency and uptake were ˜93% and 33.5 mg/g, respectively.

In a second example, 400 mg of sorbent was suspended in 200 mL of brine at pH 8 and 70° C. for 1 hour. The initial brine contained 74 mg/L Li, 283 mg/L B, 42180 mg/L Na, 3083 mg/L Mg, 5660 mg/L K, 19100 mg/L Ca, and 880 mg/L Sr (all analyses using an ICP-OES). After sorption, the sorbent was dispersed in 10 mL 0.5 M sulfuric acid at room temperature for an hour. The lithium concentration in the desorbent was 1302 ppm while concentration of other major solutes was as follows: 14 mg/L B, 58 mg/L Na, 73 mg/L Mg, 13 mg/L K, 329 mg/L Ca, 30 mg/L Sr, and 631 mg/L Mn (lost from the sorbent). The lithium extraction efficiency and uptake were more than 93% and 35.5 mg/g, respectively.

Table 6 is a table showing sorbent performance over multiple extraction/desorption cycles for a SC prepared by the co-precipitation method with a Li/Mn ratio of 3.0 and sulfuric acid as desorbent.

TABLE 6
Sorbent Performance over Multiple Extraction/Desorption
Cycles for a SC Prepared by the Co-Precipitation Method
with a Li/Mn Ratio Of 3.0 and Sulfuric Acid as Desorbent

| Sorbent Synthesis | Coprecipitation | | | | |
|---|---|---|---|---|---|
| Method | Cycle 1 | Cycle 2 | Cycle 3 | Cycle 4 | Cycle 5 |
| Brine Volume (mL) | 800 | 663 | 560 | 477 | 397 |
| Brine Lithium | 70 | 70 | 70 | 70 | 70 |
| Concentration (mg/L) | | | | | |
| Sorbent Material Used in | 1600 | 1327 | 1119 | 953 | 793 |
| extraction (mg) | | | | | |
| Sorbent Material Used in | 1487 | 1113 | 1106 | 915 | 727 |
| desorption (mg) | | | | | |
| Acid Volume (mL) | 37.2 | 28 | 28 | 22.9 | 18 |
| Acid Concentration (M) | 0.5 | 0.5 | 0.5 | 0.5 | 0.5 |
| Lithium Extraction | 60% | 46% | 69% | 63% | 63% |
| Stripping Efficiency | 100% | 100% | 97% | 91% | 88% |
| Lithium Recovery | 63% | 48% | 66% | 57% | 56% |
| Lithium Uptake (mg/g) | 21 | 16 | 24 | 22 | 22 |
| Volume Concentration | 21.5 | 23.7 | 20.0 | 20.8 | 22.1 |
| Factor | | | | | |
| Final Lithium | 942 | 787 | 928 | 836 | 858 |
| Concentration (mg/L) | | | | | |
| Lithium Concentration | 13.5 | 11.2 | 13.3 | 11.9 | 12.3 |
| Factor | | | | | |
| Sorbent loss (% after | 1.95 | 3.67 | 5.49 | 5.25 | 5.8 |
| desorption) | | | | | |

Table 7 is a table of ICP results showing cation concentrations in sample fluids for a SC prepared by the co-precipitation method with a Li/Mn ratio of 3.0 and sulfuric acid as desorbent.

TABLE 7
ICP results showing Cation Concentrations in Sample
Fluids for a SC prepared by the Co-Precipitation Method with a
Li/Mn ratio of 3.0 and Sulfuric Acid as Desorbent

| | Concentration (mg/L) | | | | | | | |
|---|---|---|---|---|---|---|---|---|
| Sample | B | Sr | Na | Mg | Ca | Mn | Li | K |
| Raw Brine | 300 | 888 | 48440 | 2900 | 20200 | 0.1 | 72 | 6400 |
| (CWB4) | | | | | | | | |
| pH Adjusted | 298 | 868 | 46040 | 2817 | 19300 | 0.1 | 70 | 6120 |
| Brine-Cycle 1 | | | | | | | | |
| pH Adjusted | 298 | 840 | 45400 | 2809 | 19240 | 0.1 | 70 | 6080 |
| Brine-Cycle 2 | | | | | | | | |
| pH Adjusted | 300 | 876 | 46220 | 2848 | 19440 | 0.1 | 70 | 6020 |
| Brine-Cycle 3 | | | | | | | | |
| pH Adjusted | 300 | 874 | 46820 | 2829 | 19340 | 0.1 | 70 | 6140 |
| Brine-Cycle 4 | | | | | | | | |
| pH Adjusted | 294 | 862 | 46160 | 2811 | 19200 | 0.1 | 70 | 6000 |
| Brine-Cycle 5 | | | | | | | | |
| Treated Brine- | 300 | 870 | 46400 | 2854 | 19580 | <DL | 28 | 6420 |
| Cycle 1 | | | | | | | | |
| Treated Brine- | 308 | 868 | 46460 | 2862 | 19760 | <DL | 38 | 6140 |
| Cycle 2 | | | | | | | | |
| Treated Brine- | 300 | 886 | 46880 | 2866 | 20120 | <DL | 22 | 6180 |
| Cycle 3 | | | | | | | | |
| Treated Brine- | 300 | 880 | 46760 | 2847 | 20080 | <DL | 26 | 6260 |
| Cycle 4 | | | | | | | | |
| Treated Brine- | 300 | 874 | 46320 | 2821 | 19660 | 0.1 | 26 | 6260 |
| Cycle 5 | | | | | | | | |
| Desorption Acid- | 14.4 | 31.5 | 91.7 | 51.5 | 282 | 431 | 942 | 23.5 |
| Cycle 1 | | | | | | | | |
| Desorption Acid- | 12.2 | 33.2 | 106.2 | 52.3 | 334 | 806 | 787 | 51.0 |
| Cycle 2 | | | | | | | | |
| Desorption Acid- | 11.3 | 41.5 | 104.1 | 58.1 | 322 | 1198 | 928 | 48.8 |
| Cycle 3 | | | | | | | | |
| Desorption Acid- | 9.8 | 43.2 | 115.2 | 59.7 | 336 | 1159 | 836 | 57.9 |
| Cycle 4 | | | | | | | | |
| Desorption Acid- | 10.3 | 47.1 | 116.3 | 61.1 | 363 | 1295 | 858 | 52.7 |
| Cycle 5 | | | | | | | | |

Table 8 is a table showing sorbent performance over multiple extraction/desorption cycles for a SC prepared by the co-precipitation method with a Li/Mn Ratio of 3.0 and ammonium persulfate as desorbent.

TABLE 8
Sorbent Performance over Multiple Extraction/Desorption Cycles
for a SC prepared by the Co-Precipitation Method with a Li/Mn
Ratio of 3.0 and Ammonium Persulfate as Desorbent

| | Coprecipitation | | | | |
|---|---|---|---|---|---|
| | Cycle | Cycle | Cycle | Cycle | Cycle |
| Sorbent Synthesis Method | 1 | 2 | 3 | 4 | 5 |
| Brine Volume (mL) | 800 | 665 | 550 | 328 | 232 |
| Brine Lithium | 64 | 64 | 64 | 62 | 62 |
| Concentration (mg/L) | | | | | |
| Sorbent Material Used in | 1606 | 1325 | 1102 | 656 | 464 |
| extraction (mg) | | | | | |
| Sorbent Material Used in | 1503 | 1274 | 947 | 562 | 425 |
| desorption (mg) | | | | | |
| Acid Volume (mL) | 37.5 | 31.9 | 23.7 | 14.05 | 10.6 |
| Acid Concentration (M) | 0.5 | 0.5 | 0.5 | 0.5 | 0.5 |
| Lithium Extraction | 69% | 53% | 50% | 61% | 58% |
| Stripping Efficiency | 74% | 98% | 91% | 84% | 94% |
| Lithium Recovery | 51% | 52% | 46% | 52% | 55% |
| Lithium Uptake (mg/g) | 21.9 | 17.1 | 16.0 | 19.0 | 18.0 |
| Volume Concentration | 21.3 | 20.8 | 23.2 | 23.3 | 21.9 |
| Factor | | | | | |
| Final Lithium | 697 | 697 | 677 | 747 | 741 |
| Concentration (mg/L) | | | | | |
| Lithium Concentration | 10.9 | 10.9 | 10.6 | 12 | 12 |
| Factor | | | | | |
| Sorbent loss (% after | 0 | 0 | 0 | 0 | 0 |
| desorption) | | | | | |

Table 9 is a table of ICP results showing cation concentrations in sample fluids for a SC prepared by the co-precipitation method with a Li/Mn ratio of 3.0 and ammonium persulfate as desorbent.

TABLE 9
ICP results showing Cation Concentrations in Sample Fluids for a
SC prepared by the Co-Precipitation Method with a Li/Mn
ratio of 3.0 and Ammonium Persulfate as Desorbent

| | Concentration (mg/L) | | | | | | | |
|---|---|---|---|---|---|---|---|---|
| Sample | B | Sr | Na | Mg | Ca | Mn | Li | K |
| Raw Brine | 300 | 866 | 47260 | 2740 | 19860 | 0.1 | 64 | 6160 |
| (CWB3) | | | | | | | | |
| pH Adjusted | 300 | 862 | 47700 | 2650 | 19880 | 0.1 | 64 | 6280 |
| Brine-Cycle 1 | | | | | | | | |
| pH Adjusted | 300 | 856 | 46740 | 2603 | 19500 | 0.1 | 64 | 6020 |
| Brine-Cycle 2 | | | | | | | | |
| pH Adjusted | 300 | 874 | 46940 | 2065 | 19680 | <DL | 64 | 6100 |
| Brine-Cycle 3 | | | | | | | | |
| pH Adjusted | 300 | 858 | 47140 | 2641 | 19740 | 0.1 | 62 | 6020 |
| Brine-Cycle 4 | | | | | | | | |
| pH Adjusted | 300 | 862 | 47240 | 2697 | 19540 | 0.1 | 62 | 6200 |
| Brine-Cycle 5 | | | | | | | | |
| Treated Brine- | 290 | 852 | 47340 | 2702 | 19760 | <DL | 20 | 6120 |
| Cycle 1 | | | | | | | | |
| Treated Brine- | 290 | 842 | 46360 | 2726 | 19500 | <DL | 30 | 5660 |
| Cycle 2 | | | | | | | | |
| Treated Brine- | 286 | 840 | 46580 | 2739 | 19700 | <DL | 32 | 6060 |
| Cycle 3 | | | | | | | | |
| Treated Brine- | 290 | 848 | 46740 | 2706 | 19360 | 0.1 | 24 | 6300 |
| Cycle 4 | | | | | | | | |
| Treated Brine- | 290 | 854 | 47040 | 2768 | 19580 | 0.2 | 26 | 6500 |
| Cycle 5 | | | | | | | | |
| Desorption | 10 | 32.2 | 84.8 | 48.8 | 266 | <DL | 697 | 23.2 |
| Acid-Cycle 1 | | | | | | | | |
| Desorption | 14 | 53.3 | 85.6 | 62.6 | 377 | 0.2 | 697 | 40.1 |
| Acid-Cycle 2 | | | | | | | | |
| Desorption | 15 | 58.3 | 82.6 | 65.0 | 427 | 0.4 | 677 | 56.0 |
| Acid-Cycle 3 | | | | | | | | |
| Desorption | 13 | 58.5 | 75.5 | 72.7 | 476 | 0.9 | 747 | 64.9 |
| Acid-Cycle 4 | | | | | | | | |
| Desorption | 15 | 52.4 | 80.9 | 74 7. | 511 | 0.7 | 741 | 77.2 |
| Acid-Cycle 5 | | | | | | | | |

Table 10 is a table showing sorbent performance over multiple extraction/desorption cycles for a SC prepared by the co-precipitation method with a Li/Mn Ratio of 0.8 and sulfuric acid as desorbent.

TABLE 10
Sorbent Performance over Multiple Extraction/Desorption
Cycles for a SC prepared by the Solid Phase Method with
a Li/Mn Ratio of 0.8 and Sulfuric Acid as Desorbent

| Sorbent Synthesis | Solid Phase | | | | |
|---|---|---|---|---|---|
| Method | Cycle 1 | Cycle 2 | Cycle 3 | Cycle 4 | Cycle 5 |
| Brine Volume (mL) | 800 | 703.5 | 594 | 497 | 402.5 |
| Brine Lithium | 70 | 70 | 70 | 70 | 70 |
| Concentration (mg/L) | | | | | |
| Sorbent Material Used in | 1600 | 1407 | 1188 | 994 | 805 |
| extraction (mg) | | | | | |
| Sorbent Material Used in | 1552 | 1230 | 1100 | 920 | 710 |
| desorption (mg) | | | | | |
| Acid Volume (mL) | 38.8 | 30.75 | 27.5 | 23 | 18 |
| Acid Concentration (M) | 0.5 | 0.5 | 0.5 | 0.5 | 0.5 |
| Lithium Extraction | 77% | 69% | 69% | 74% | 74% |
| Stripping Efficiency | 100% | 100% | 100% | 92% | 89% |
| Lithium Recovery | 79% | 70% | 68% | 68% | 66% |
| Lithium Uptake (mg/g) | 27 | 24 | 24 | 26 | 26 |
| Volume Concentration | 20.6 | 22.9 | 21.6 | 21.6 | 22.4 |
| Factor | | | | | |
| Final Lithium | 1143 | 1115 | 1032 | 1028 | 1054 |
| Concentration (mg/L) | | | | | |
| Lithium Concentration | 16.3 | 15.9 | 14.7 | 14.7 | 15.1 |
| Factor | | | | | |
| Sorbent loss (% after | 3.08 | 4.83 | 4.62 | 4.98 | 5.39 |
| desorption) | | | | | |

Table 11 is a table of ICP results showing cation concentrations in sample fluids over multiple extraction/desorption cycles for a SC prepared by the solid phase method with a Li/Mn ratio of 0.8 and sulfuric acid as desorbent.

TABLE 11
ICP Results of Cation Concentrations in Sample Fluids Over Multiple
Extraction/Desorption Cycles for a SC Prepared by the Solid Phase
Method with a Li/Mn Ratio of 0.8 and Sulfuric Acid as Desorbent

| | Concentration (mg/L) | | | | | | | |
|---|---|---|---|---|---|---|---|---|
| Sample | B | Sr | Na | Mg | Ca | Mn | Li | K |
| pH | 294 | 858 | 45600 | 2839 | 19040 | 0.1 | 70 | 6080 |
| Adjusted | | | | | | | | |
| Brine- | | | | | | | | |
| Cycle 1 | | | | | | | | |
| pH | 298 | 872 | 46440 | 2830 | 19360 | 0.1 | 70 | 6260 |
| Adjusted | | | | | | | | |
| Brine- | | | | | | | | |
| Cycle 2 | | | | | | | | |
| pH | 298 | 876 | 46400 | 2847 | 19420 | 0.1 | 70 | 6080 |
| Adjusted | | | | | | | | |
| Brine- | | | | | | | | |
| Cycle 3 | | | | | | | | |
| pH | 296 | 864 | 45800 | 2791 | 19260 | 0.1 | 70 | 5940 |
| Adjusted | | | | | | | | |
| Brine- | | | | | | | | |
| Cycle 4 | | | | | | | | |
| pH | 296 | 862 | 45740 | 2869 | 19080 | 0.1 | 70 | 6040 |
| Adjusted | | | | | | | | |
| Brine- | | | | | | | | |
| Cycle 5 | | | | | | | | |
| Treated | 310 | 886 | 46800 | 2885 | 19920 | <DL | 1 | 6340 |
| Brine- | | | | | | | | |
| Cycle 1 | | | | | | | | |
| Treated | 300 | 882 | 46780 | 2832 | 19880 | <DL | 22 | 6200 |
| Brine- | | | | | | | | |
| Cycle 2 | | | | | | | | |
| Treated | 300 | 880 | 46280 | 2863 | 19620 | <DL | 22 | 6260 |
| Brine- | | | | | | | | |
| Cycle 3 | | | | | | | | |
| Treated | 300 | 872 | 46620 | 2866 | 20060 | 0.1 | 18 | 6840 |
| Brine- | | | | | | | | |
| Cycle 4 | | | | | | | | |
| Treated | 300 | 876 | 46920 | 2894 | 19720 | <DL | 18 | 6440 |
| Brine- | | | | | | | | |
| Cycle 5 | | | | | | | | |
| Desorption | 9.4 | 12.0 | 147.6 | 13.5 | 91.7 | 680 | 1143 | 20.9 |
| Acid- | | | | | | | | |
| Cycle 1 | | | | | | | | |
| Desorption | 8.3 | 20.4 | 159.5 | 15.3 | 132.8 | 1067 | 1115 | 31.3 |
| Acid- | | | | | | | | |
| Cycle 2 | | | | | | | | |
| Desorption | 9.5 | 25.3 | 148.8 | 16.7 | 158.9 | 1021 | 1032 | 41.1 |
| Acid- | | | | | | | | |
| Cycle 3 | | | | | | | | |
| Desorption | 7.6 | 30.5 | 121.8 | 19.0 | 197.5 | 1100 | 1028 | 39.1 |
| Acid- | | | | | | | | |
| Cycle 4 | | | | | | | | |
| Desorption | 9.4 | 35.0 | 112.0 | 22.8 | 234.1 | 1189 | 1054 | 36.7 |
| Acid- | | | | | | | | |
| Cycle 5 | | | | | | | | |

Table 12 is a table showing sorbent performance over multiple extraction/desorption cycles for a SC prepared by the solid phase method with a Li/Mn ratio of 0.8 and ammonium persulfate as desorbent.

TABLE 12
Sorbent Performance Over Multiple Extraction/Desorption
Cycles for a SC Prepared by the Solid Phase Method with
a Li/Mn Ratio of 0.8 and Ammonium Persulfates Desorbent

| | Solid Phase | | | | |
|---|---|---|---|---|---|
| Sorbent Synthesis | Cycle | Cycle | Cycle | Cycle | Cycle |
| Method | 1 | 2 | 3 | 4 | 5 |
| Brine Volume (mL) | 800 | 687 | 559 | 460.5 | 373 |
| Brine Lithium | 64 | 64 | 64 | 64 | 64 |
| Concentration (mg/L) | | | | | |
| Sorbent Material Used in | 1603 | 1374 | 1118 | 921 | 746 |
| extraction (mg) | | | | | |
| Sorbent Material Used in | 1483 | 1248 | 1046 | 855 | 633 |
| desorption (mg) | | | | | |
| Acid Volume (mL) | 37.075 | 31.2 | 26.15 | 21.375 | 15.8 |
| Acid Concentration (M) | 0.5 | 0.5 | 0.5 | 0.5 | 0.5 |
| Lithium Extraction | 75% | 41% | 53% | 59% | 50% |
| Stripping Efficiency | 67% | 100% | 92% | 69% | 85% |
| Lithium Recovery | 51% | 48% | 49% | 41% | 43% |
| Lithium Uptake (mg/g) | 24 | 13 | 17 | 19 | 16 |
| Volume Concentration | 21.6 | 22 | 21.4 | 21.5 | 23.6 |
| Factor | | | | | |
| Final Lithium | 697 | 669 | 671 | 565 | 645 |
| Concentration (mg/L) | | | | | |
| Lithium Concentration | 10.9 | 10.5 | 10.5 | 8.8 | 10.1 |
| Factor | | | | | |
| Sorbent loss (% after | 0 | 0 | 0.06 | 0 | 0 |
| desorption) | | | | | |

Table 13 is a table of ICP results showing cation concentrations in sample fluids over multiple extraction/desorption cycles for a SC prepared by the solid phase method with a Li/Mn ratio of 0.8 and ammonium persulfate as desorbent.

TABLE 13
ICP Results showing Cation Concentrations in Sample Fluids Multiple
Extraction/Desorption Cycles for a SC Prepared by the Co-Precipitation
Method with a Li/Mn Ratio of 3.0 and Ammonium Persulfate as Desorbent

| | Concentration (mg/L) | | | | | | | |
|---|---|---|---|---|---|---|---|---|
| Sample | B | Sr | Na | Mg | Ca | Mn | Li | K |
| Raw Brine | 300 | 866 | 47260 | 2740 | 19860 | 0.1 | 64 | 6160 |
| (CWB3) | | | | | | | | |
| pH | 300 | 862 | 46760 | 2615 | 19440 | 0.1 | 64 | 6060 |
| Adjusted | | | | | | | | |
| Brine- | | | | | | | | |
| Cycle 1 | | | | | | | | |
| pH | 300 | 860 | 47460 | 2630 | 19680 | 0.1 | 64 | 6160 |
| Adjusted | | | | | | | | |
| Brine- | | | | | | | | |
| Cycle 2 | | | | | | | | |
| pH | 300 | 862 | 46520 | 2640 | 19560 | 0.1 | 64 | 6040 |
| Adjusted | | | | | | | | |
| Brine- | | | | | | | | |
| Cycle 3 | | | | | | | | |
| pH | 300 | 852 | 46540 | 2617 | 19660 | 0.1 | 64 | 6020 |
| Adjusted | | | | | | | | |
| Brine- | | | | | | | | |
| Cycle 4 | | | | | | | | |
| pH | 300 | 880 | 46340 | 2639 | 19520 | 0.1 | 64 | 5960 |
| Adjusted | | | | | | | | |
| Brine- | | | | | | | | |
| Cycle 5 | | | | | | | | |
| Treated | 294 | 850 | 46940 | 2748 | 19320 | <DL | 16 | 6300 |
| Brine- | | | | | | | | |
| Cycle 1 | | | | | | | | |
| Treated | 298 | 864 | 47500 | 2733 | 19860 | <DL | 38 | 6200 |
| Brine- | | | | | | | | |
| Cycle 2 | | | | | | | | |
| Treated | 290 | 848 | 46740 | 2719 | 19560 | <DL | 30 | 6020 |
| Brine- | | | | | | | | |
| Cycle 3 | | | | | | | | |
| Treated | 290 | 840 | 47860 | 2752 | 19920 | <DL | 26 | 6080 |
| Brine- | | | | | | | | |
| Cycle 4 | | | | | | | | |
| Treated | 290 | 844 | 46140 | 2784 | 19520 | <DL | 32 | 5940 |
| Brine- | | | | | | | | |
| Cycle 5 | | | | | | | | |
| Desorption | 7 | 11.1 | 159.4 | 9.7 | 97 | <DL | 621 | 24.1 |
| Acid- | | | | | | | | |
| Cycle 1 | | | | | | | | |
| Desorption | 10 | 27.0 | 139.9 | 16.5 | 202 | 0.3 | 669 | 42.1 |
| Acid- | | | | | | | | |
| Cycle 2 | | | | | | | | |
| Desorption | 13 | 42.7 | 160.7 | 25.0 | 310 | 12.2 | 671 | 60.3 |
| Acid- | | | | | | | | |
| Cycle 3 | | | | | | | | |
| Desorption | 13 | 51.6 | 108.2 | 26.6 | 379 | 0.1 | 565 | 64.4 |
| Acid- | | | | | | | | |
| Cycle 4 | | | | | | | | |
| Desorption | 13 | 46.5 | 110.3 | 24.6 | 340 | 0.5 | 645 | 73.6 |
| Acid- | | | | | | | | |
| Cycle 5 | | | | | | | | |

The results show that the PSCs are effective in concentrating Li by a factor of greater than 10 and that the SCs can be cycled multiple times.

Generally, higher temperatures improve the reaction kinetics, where for example a Li uptake capacity of 18 mg/g can be achieved in 5 min at 70° C. and equilibrium Li uptake of 25 mg/g after 30 min. Lithium extraction efficiency is as high as 99% with lithium uptake capacity reaching as high as 35 mg of lithium absorbed and desorbed per g of sorbent under optimum conditions.

The use of different desorbents affects sorbent loss defined as manganese loss to desorption fluid where ammonium persulfate showed a reduction in sorbent loss as compared to sulfuric acid.

### Batch Testing

Table 14 shows batch testing of a SC prepared with Li/Mn ratio of 3.0 by the co-precipitation method to measure lithium extraction, stripping efficiency, lithium recovery and lithium uptake.

TABLE 14
Batch Testing of a SC prepared with Li/Mn
ratio of 3.0 by the Co-precipitation Method

| | Co-precipitation | | |
|---|---|---|---|
| Sorbent Synthesis Method | Test 1 | Test 2 | Test 3 |
| Brine Volume (mL) | 200 | 200 | 200 |
| Brine Lithium Concentration (mg/L) | 70 | 70 | 72 |
| Sorbent Material Used in | 400 | 400 | 400 |
| extraction (mg) | | | |
| Sorbent Material Used in | 350 | 360 | 380 |
| desorption (mg) | | | |
| Acid Volume (mL) | 8.75 | 9 | 9.5 |
| Acid Concentration (M) | 0.5 | 0.5 | 0.5 |
| Lithium Extraction | 100% | 100% | 100% |
| Stripping Efficiency | 100% | 99% | 96% |
| Lithium Recovery | 100% | 99% | 96% |
| Lithium Uptake (mg/g) | 35 | 35 | 36 |
| Volume Concentration Factor | 22.9 | 22.2 | 21.1 |
| Final Lithium Concentration (mg/L) | 1603 | 1533 | 1456 |
| Lithium Concentration Factor | 22.9 | 21.9 | 20.2 |
| Sorbent loss (% after desorption) | 2.53 | 2.35 | 2.46 |

Table 15 shows ICP results of batch testing of a SC prepared by the co-precipitation method with a Li/Mn of 3.0.

TABLE 15
ICP results of Batch Testing of a SC prepared by the
Co-Precipitation Method with a Li/Mn of 3.0

| | Concentration (mg/L) | | | | | | | |
|---|---|---|---|---|---|---|---|---|
| Sample | B | Sr | Na | Mg | Ca | Mn | Li | K |
| pH Adjusted | 300 | 880 | 46500 | 3300 | 19680 | 0.1 | 70 | 6120 |
| Brine-Test 1 | | | | | | | | |
| pH Adjusted | 280 | 860 | 44660 | 3300 | 18860 | 0.1 | 70 | 5920 |
| Brine-Test 2 | | | | | | | | |
| pH Adjusted | 300 | 880 | 45880 | 3400 | 19540 | 0.1 | 72 | 6060 |
| Brine-Test 3 | | | | | | | | |
| Treated Brine- | 300 | 900 | 47860 | 3400 | 20300 | <DL | <DL | 6760 |
| Test 1 | | | | | | | | |
| Treated Brine- | 280 | 892 | 45240 | 3200 | 19500 | <DL | <DL | 5800 |
| Test 2 | | | | | | | | |
| Treated Brine- | 300 | 900 | 47260 | 3300 | 20600 | <DL | <DL | 6040 |
| Test 3 | | | | | | | | |
| Desorption Acid- | 19.5 | 33.5 | 87.8 | 75.5 | 335 | 560 | 1603 | 12.6 |
| Test 1 | | | | | | | | |
| Desorption Acid- | 19.6 | 32.0 | 98.7 | 73.0 | 323 | 520 | 1533 | 16.7 |
| Test 2 | | | | | | | | |
| Desorption Acid- | 18.8 | 31.1 | 105.6 | 73.3 | 315 | 544 | 1456 | 15.2 |
| Test 3 | | | | | | | | |

Table 16 shows batch testing of a SC prepared with Li/Mn ratio of 0.8 by the solid phase method to measure lithium extraction, stripping efficiency, lithium recovery and lithium uptake.

TABLE 16
Batch Testing of a SC prepared with Li/Mn
ratio of 0.8 by the Solid Phase Method

| | Solid Phase | | |
|---|---|---|---|
| Sorbent Synthesis Method | Test 1 | Test 2 | Test 3 |
| Brine Volume (mL) | 200 | 200 | 200 |
| Brine Lithium Concentration (mg/L) | 78 | 78 | 78 |
| Sorbent Material Used in extraction (mg) | 399 | 400 | 402 |
| Sorbent Material Used in desorption (mg) | 364 | 370 | 324 |
| Acid Volume (mL) | 9.1 | 9.25 | 8.1 |
| Acid Concentration (M) | 0.5 | 0.5 | 0.5 |
| Lithium Extraction | 100% | 100% | 100% |
| Stripping Efficiency | 86% | 87% | 87% |
| Lithium Recovery | 86% | 87% | 87% |
| Lithium Uptake (mg/g) | 39 | 39 | 38.8 |
| Volume Concentration Factor | 22 | 21.6 | 24.7 |
| Final Lithium Concentration (mg/L) | 1478 | 1471 | 1670 |
| Lithium Concentration Factor | 18.9 | 18.9 | 21.4 |
| Sorbent loss (% after desorption) | 2.32 | 2.41 | 2.7 |

Table 17 shows ICP results of batch testing of a SC prepared by the solid phase method with a Li/Mn of 0.8.

TABLE 17
ICP results of Batch Testing of a SC prepared by the
Solid Phase Method with a Li/Mn of 0.8

| | Concentration (mg/L) | | | | | | | |
|---|---|---|---|---|---|---|---|---|
| Sample | B | Ca | K | Li | Mg | Mn | Na | Sr |
| pH Adjusted Brine | 260 | 20800 | 6440 | 78 | 3568 | 0.2 | 48000 | 860 |
| Tests 1-3 | | | | | | | | |
| Treated Brine- | 280 | 20660 | 6400 | <DL | 3576 | <DL | 48400 | 890 |
| Test 1 | | | | | | | | |
| Treated Brine- | 260 | 20620 | 6450 | <DL | 3531 | <DL | 48000 | 840 |
| Test 2 | | | | | | | | |
| Treated Brine- | 280 | 20620 | 6380 | <DL | 3533 | <DL | 48200 | 860 |
| Test 3 | | | | | | | | |
| Desorption Acid- | 13.0 | 198 | 14.8 | 1478 | 26.7 | 525 | 166.9 | 18.1 |
| Test 1 | | | | | | | | |
| Desorption Acid- | 14.0 | 189 | 13.7 | 1471 | 25.9 | 546 | 177.1 | 18.0 |
| Test 2 | | | | | | | | |
| Desorption Acid- | 14.0 | 240 | 16.5 | 1670 | 29.6 | 610 | 204.6 | 20.8 |
| Test 3 | | | | | | | | |

The results show that the sorbents are effective in terms of lithium extraction, stripping efficiency, lithium recovery, lithium uptake (mg/g), volume concentration factor, final lithium concentration (mg/l), lithium concentration factor and sorbent loss (% after desorption) for use of the SCs in concentrating lithium.

1) A sorbent composition (SC) of the formula Li_{1.3-1.6}Mn_{1.6-1.7}O₄ having a crystal structure enabling a reversable exchange of hydrogen and lithium ions within the composition, the sorbent composition effective for selectively concentrating lithium from a lithium brine via an ion exchange process, the crystal structure having a majority of ion exchange sites in relation to redox sites.

2) The sorbent composition of claim 1 wherein the crystal structure has a ratio of ion exchange sites to redox sites greater than 2:1.

3) The sorbent composition of claim 1 wherein the crystal structure has a ratio of ion exchange sites to redox sites greater than 5:1.

4) The sorbent composition of claim 1 wherein the crystal structure has a ratio of ion exchange sites to redox sites greater than 15:1.

5)-48) (canceled)
